(19) United States
(12) Patent Application Publication
(10) Pub. No.: US 2019/0389048 A1
(43) Pub. Date: Dec. 26, 2019

(54) TRANSMISSION SHAFT

(71) Applicant: Fairway Electronic Co., Ltd., New Taipei City (TW)

(72) Inventors: Lin-Han YEN, New Taipei City (TW); Chien-Hsiung HSIEH, New Taipei City (TW)

(21) Appl. No.: 16/145,832

(22) Filed: Sep. 28, 2018

(30) Foreign Application Priority Data
Jun. 22, 2018 (TW) 107121482

(51) Int. Cl. B25F 5/00; F16D 1/10; F16C 3/02

(52) U.S. Cl. CPC B25F 5/001; F16D 2001/102; F16C 3/02; F16D 1/101

(57) ABSTRACT

A transmission shaft comprises a first rotating shaft and a second rotating shaft. The first rotating shaft has a first connecting end. The second rotating shaft has a second connecting end. The first connecting end is used for driving the second connecting end to rotate the second rotating shaft when the first rotating shaft rotates.

### RELATED APPLICATIONS

The present application claims the priority of Taiwan Application No. 107121482, filed on Jun. 22, 2018, the disclosure of which is hereby incorporated by reference herein in its entirety.

### BACKGROUND OF THE INVENTION

### 1. Field of the Invention

The present disclosure generally relates to a transmission shaft, and, more particularly, to a transmission shaft applied to a handheld tool.

### 2. Description of the Related Art

In general, a handheld tool includes a motor, a transmission, a tool part, and a housing. Among them, the transmission includes a gear train or a worm with a worm gear, and a transmission shaft, etc. The transmission is used to cooperate with the motor to drive the tool part.

In the prior art, a handheld tool such as a grinder presses the tool part on a workpiece when using. The pressure generated at this time is exerted on the gear train or the worm with the worm gear through the transmission shaft to increase the friction between the components. As a result, the operation of the motor and the transmission are hindered and the efficiency of the handheld tool is reduced. In addition, the positions of the two ends of the transmission shaft are fixed when the handheld tool is assembled. Thus, the transmission shaft formed in one piece in the prior art will not be able to rotate smoothly if there is an error in the fixed positions of the two ends. Therefore, how to provide a transmission shaft that can avoid the pressure interfering with the operation of the motor and the transmission and tolerate a large error in assembly has become an urgent problem to be solved by the industry.

### SUMMARY OF THE INVENTION

In light of solving the foregoing problems of the prior art, one purpose of the present invention is to provide a transmission shaft that can prevent the operation of the motor and the transmission from being interfered with by the pressure and tolerate a large error in assembly.

In order to achieve the above purposes, the transmission shaft according to the present invention comprises a first rotating shaft and a second rotating shaft.

The first rotating shaft has a first connecting end. The second rotating shaft has a second connecting end. The first connecting end is used for driving the second connecting end to rotate the second rotating shaft when the first rotating shaft rotates.

In an embodiment, the first rotating shaft and the second rotating shaft are not in direct contact in a plane perpendicular to an axis.

In an embodiment, one of the first connecting end and the second connecting end is a convex structure, and the other is a concave structure corresponding to the shape of the convex structure.

In an embodiment, the transmission shaft according to the present invention further comprises an epicyclic gearing carrier disposed on the first rotating shaft.

In an embodiment, the transmission shaft according to the present invention further comprises a first frame used to withstand the epicyclic gearing carrier.

In an embodiment, the transmission shaft according to the present invention further comprises a worm gear or a gear connected to the first rotating shaft.

In an embodiment, the transmission shaft according to the present invention further comprises an epicyclic gearing connected to the worm gear or the gear.

In an embodiment, the transmission shaft according to the present invention further comprises a bearing connected to the second rotating shaft.

In an embodiment, the transmission shaft according to the present invention further comprises a second frame connected to the bearing.

In an embodiment, the transmission shaft according to the present invention further comprises a third frame connected to the other end of the first rotating shaft opposite to the first connecting end.

In an embodiment, the second rotating shaft further comprises a slot disposed at the other end opposite to the second connecting end.

In contrast with the transmission shaft formed in one piece in the prior art, the transmission shaft according to the present invention comprises a first rotating shaft and a second rotating shaft. A first connecting end of the first rotating shaft is used for driving a second connecting end of the second rotating shaft to rotate the second rotating shaft when the first rotating shaft rotates. Therefore, the transmission shaft according to the present invention can tolerate a larger error in assembly (compared to the transmission shaft formed in one piece). Further, the pressure on the second rotating shaft is not directly applied to the first rotating shaft connecting the power source because the first rotating shaft and the second rotating shaft are not in direct contact in the plane perpendicular to the axis. Therefore, the pressure does not affect the operation of the transmission shaft or power source. In addition, it is also possible to attach a first frame or a third frame to maintain the position of the first rotating shaft or to attach a bearing and a second frame to maintain the position of the second rotating shaft so that the effect of avoiding the pressure is further improved.

### BRIEF DESCRIPTION OF THE DRAFLAPS

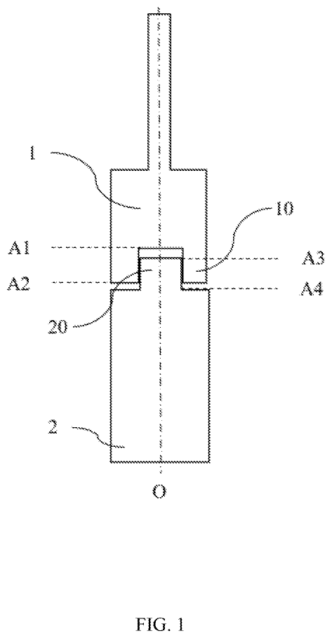

FIG. 1 illustrates a schematic diagram of a structure of a transmission shaft according to a first embodiment of the present invention;

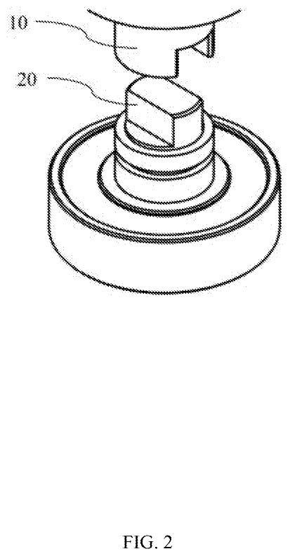

FIG. 2 illustrates a stereoscopic schematic diagram of a first connecting end and a second connecting end according to a second embodiment of the present invention;

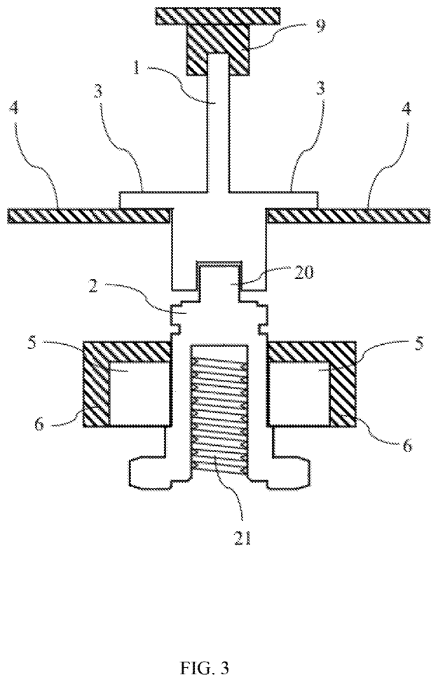

FIG. 3 illustrates a schematic diagram of a structure of a transmission shaft according to a third embodiment of the present invention; and

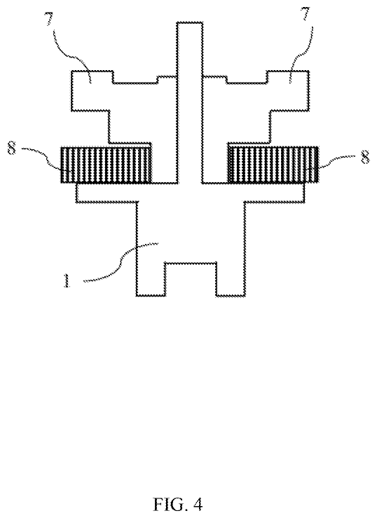

FIG. 4 illustrates a schematic diagram of a structure of a first rotating shaft according to a fourth embodiment of the present invention.

### DETAILED DESCRIPTION

The present invention is described by the following specific embodiments. Those with ordinary skills in the arts can readily understand other advantages and functions of the present invention after reading the disclosure of this specification. Any changes or adjustments made to their relative relationships, without modifying the substantial technical contents, are also to be construed as within the range implementable by the present invention.

Please refer to FIG. 1. FIG. 1 illustrates a schematic diagram of a structure of a transmission shaft according to a first embodiment of the present invention. As shown, a transmission shaft according to the present invention comprises a first rotating shaft 1 and a second rotating shaft 2. The transmission shaft according to the present invention is mainly applied in the field of handheld tools.

In an embodiment, the first rotating shaft 1 has a first connecting end 10. The first rotating shaft 1 is indirectly connected to a power source (such as a motor) through other transmission components. The second rotating shaft 2 has a second connecting end 20. The second rotating shaft 2 can be directly or indirectly connect to a tool part (for example, a grinding disc or a drill, etc.).

The first connecting end 10 is used for driving the second connecting end 20 to rotate the second rotating shaft 2 when the first rotating shaft 1 rotates. In order to achieve this purpose, the shapes of the first connecting end 10 and the second connecting end 20 must correspond to each other. For example, the first connecting end 10 is a concave structure, and the second connecting end 20 is a convex structure corresponding to the shape of the convex structure, but not limited thereto.

In general, the positions of the two ends of the transmission shaft are fixed when it is assembled. The transmission shaft formed in one piece in the prior art cannot rotate smoothly if an error is occurring between the fixed positions of the two ends and causes axis deviation. The two ends of the transmission shaft according to the present invention are the first rotating shaft 1 and the second rotating shaft 2 respectively. The first rotating shaft 1 and the second rotating shaft 2 can still rotate independently even if there is an error between the fixed positions of the two ends, as long as the first connecting end 10 can drive the second connecting end 20. In other words, the transmission shaft according to the present invention can tolerate a large error in assembly.

In an embodiment, the axis of the first rotating shaft 1 and the axis of the second rotating shaft 2 are on the same axis O. The planes A1, A2 perpendicular to the axis O of the first rotating shaft 1 and the planes A3, A4 perpendicular to the axis O of the second rotating shaft 2 are not in direct contact. As shown in FIG. 1, The first rotating shaft 1 and the second rotating shaft 2 have gaps and are not in direct contact between the planes A1 and A3 and between the planes A2 and A4. The first rotating shaft 1 and the second rotating shaft 2 are in contact with each other only in the planes that are substantially parallel to the direction of the axis O. The second rotating shaft 2 of the transmission shaft is subjected to pressure in the direction of the axis O when using the handheld tool. However, the first rotating shaft 1 is not subjected to pressure in the direction of the axis O since the first rotating shaft 1 and the second rotating shaft 2 are not in direct contact in the planes A1, A2, A3, A4 perpendicular to the axis O. It can avoid interfering the operation of the transmission shaft or power source due to the pressure in the direction of the axis O increasing the friction between components.

Please refer to FIG. 2. FIG. 2 illustrates a stereoscopic schematic diagram of a first connecting end and a second connecting end according to a second embodiment of the present invention. In an embodiment, the first connecting end 10 is a convex structure, and the second connecting end 20 is a concave structure corresponding to the shape of the convex structure, but not limited thereto. In another embodiment, the first connecting end 10 is a concave structure, and the second connecting end 20 is a convex structure correspondingly.

Please refer to FIG. 3. FIG. 3 illustrates a schematic diagram of a structure of a transmission shaft according to a third embodiment of the present invention. In an embodiment, the transmission shaft according to the present invention further comprises an epicyclic gearing carrier 3 disposed on the first rotating shaft 1. For example, the epicyclic gearing carrier 3 is in the form of a circular disk and is sleeved on the first rotating shaft 1 or integrally formed with the first rotating shaft 1.

In an embodiment, the transmission shaft according to the present invention further comprises a first frame 4 used to withstand the epicyclic gearing carrier 3. For example, the first frame 4 is part of a handheld tool housing. The first frame 4 is used to maintain the position of the first rotating shaft 1 so as to avoid the influence of the pressure in the direction of the axis O.

In an embodiment, the transmission shaft according to the present invention further comprises a bearing 5 connected to the second rotating shaft 2.

In an embodiment, the transmission shaft according to the present invention further comprises a second frame 6 connected to the bearing 5. For example, the second frame 6 is part of a handheld tool housing. The bearing 5 and the second frame 6 are used to maintain the position of the second rotating shaft 2 so as to prevent the first rotating shaft 1 from being affected by the pressure in the direction of the axis O.

In an embodiment, the transmission shaft according to the present invention further comprises a third frame 9 connected to the other end of the first rotating shaft 1 opposite to the first connecting end 10. For example, the third frame 9 is part of a handheld tool housing. The third frame 9 is used to maintain the position of the first rotating shaft 1.

Further, it generates pressure in the direction of the axis O when the handheld tool is in operation. However, the position of the first rotating shaft 1 is fixed through the first frame 4 and the third frame 9 and the position of the second rotating shaft 2 is fixed through the bearing 5 and second frame 6. Thus, the relative position of the first rotating shaft 1 and the second rotating shaft 2 in the direction of the axis O is maintained fixed, so as to avoid direct contact between the first rotating shaft 1 and the second rotating shaft 2 in the plane perpendicular to the shaft O. Therefore, the pressure in the direction of the axis O will only be applied to the second rotating shaft 2 and will not be applied to the first rotating shaft 1, so the pressure will not interfere the operation of the transmission shaft or power source.

Please refer to FIG. 4. FIG. 4 illustrates a schematic diagram of a structure of a first rotating shaft according to a fourth embodiment of the present invention. In an embodiment, the transmission shaft according to the present invention further comprises a worm gear 7 or a gear (not shown) connected to the first rotating shaft 1. The worm gear 7 or the gear are used to connect with other transmission components, for example with a worm or other gears. The worm gear 7 or the gear are in conjunction with the power source so as to drive the first rotating shaft 1 rotating.

In an embodiment, the transmission shaft according to the present invention further comprises an epicyclic gearing 8 connected to the worm gear 7 or the gear. The epicyclic gearing 8 is disposed on the epicyclic gearing carrier 3.

As shown in FIG. 3, in an embodiment, the second rotating shaft further comprises a slot 21 disposed at the other end opposite to the second connecting end 20. The slot 21 is used to connect to a tool part (for example, a grinding disc or a drill, etc.). The slot 21 has internal threads or fasteners and the like for fixing the tool part.

In summary, the transmission shaft according to the present invention comprises a first rotating shaft and a second rotating shaft. A first connecting end of the first rotating shaft is used for driving a second connecting end of the second rotating shaft to rotate the second rotating shaft when the first rotating shaft rotates. Therefore, the transmission shaft according to the present invention can tolerate a large error in assembly (compared to the transmission shaft formed in one piece). Further, the pressure on the second rotating shaft is not directly applied to the first rotating shaft connecting the power source because the first rotating shaft and the second rotating shaft are not in direct contact in the plane perpendicular to the axis. Therefore, the pressure does not affect the operation of the transmission shaft or power source. In addition, it is also possible to attach a first frame or a third frame to maintain the position of the first rotating shaft or to attach a bearing and a second frame to maintain the position of the second rotating shaft so that the effect of avoiding the pressure is further improved.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A transmission shaft, comprising:
a first rotating shaft having a first connecting end; and
a second rotating shaft having a second connecting end, wherein
the first connecting end is used for driving the second connecting end to rotate the second rotating shaft when the first rotating shaft rotates.

2. The transmission shaft of claim 1, wherein the first rotating shaft and the second rotating shaft are not in direct contact in a plane perpendicular to an axis.

3. The transmission shaft of claim 1, wherein one of the first connecting end and the second connecting end is a convex structure, and the other is a concave structure corresponding to the shape of the convex structure.

4. The transmission shaft of claim 1, further comprising an epicyclic gearing carrier disposed on the first rotating shaft.

5. The transmission shaft of claim 4, further comprising a first frame used to withstand the epicyclic gearing carrier.

6. The transmission shaft of claim 4, further comprising a worm gear or a gear connected to the first rotating shaft.

7. The transmission shaft of claim 6, further comprising an epicyclic gearing connected to the worm gear or the gear.

8. The transmission shaft of claim 1, further comprising a bearing connected to the second rotating shaft.

9. The transmission shaft of claim 8, further comprising a second frame connected to the bearing.

10. The transmission shaft of claim 1, further comprising a third frame connected to the other end of the first rotating shaft opposite to the first connecting end.

11. The transmission shaft of claim 1, wherein the second rotating shaft further comprises a slot disposed at the other end opposite to the second connecting end.
